(19) United States
(12) Patent Application Publication
(10) Pub. No.: US 2015/0102671 A1
(43) Pub. Date: Apr. 16, 2015

(54) DIRECT CURRENT POWER TRANSMISSION SYSTEM

(71) Applicant: General Electric Company, Schenectady, NY (US)

(72) Inventors: Luis José Garcés Rivera, Niskayuna, NY (US); Dong Dong, Schenectady, NY (US); Rixin Lai, Clifton Park, NY (US); Di Zhang, Schenectady, NY (US)

(73) Assignee: General Electric Company, Schenectady, NY (US)

(21) Appl. No.: 14/054,204

(22) Filed: Oct. 15, 2013

(51) Int. Cl. H02J 1/08; H02M 7/06

(52) U.S. Cl. CPC H02J 1/08; H02M 7/06
USPC 307/31; 363/126

(57) ABSTRACT

A system for transmitting direct current (DC) power includes a system DC link for carrying power from a source to a plurality of loads and alternating current (AC) to DC power converter modules coupled in series to the system DC link on a supply side of the system DC link. At least one AC to DC power converter module is connected to the source via at least one controllable semiconductor switch such that when the controllable semiconductor switch is not conducting, the at least one AC to DC power converter module adds about zero voltage to a system DC link voltage and provides a path for a DC link current

### BACKGROUND

This invention relates generally to converter topologies useful for direct current (DC) power transmission and distribution, and more particularly to a DC transmission and distribution system for sub-sea loads.

Transportation of electrical power to sub-sea electrical equipment such as in oil and gas facilities often requires high power being transported over long distances. Transmission for sub-sea equipment is used to supply the power from the onshore utility to the point where the power starts to be distributed among individual loads. At this point, a step down transformer is usually involved to bring the high voltage level of the transmission stage to a lower voltage level for the distribution stage to individual units of the electrical equipment. The distribution distance is typically shorter than the transmission distance, and the associated power and voltage levels to be supplied to individual loads or load clusters are lower than that of the transmission stage. Typically the transmission power is on the order of one hundred megawatts.

For applications wherein bulk power is transmitted over long distances, alternating current (AC) transmission provides technical challenges. Capacitance causes charging current to flow along the length of the AC cable. Because the cable must carry this current as well as the useful load current, this physical limitation reduces the load carrying capability of the cable. Because capacitance is distributed along the entire length of the cable, longer lengths result in higher capacitance and higher resulting charging current. As the cable system design voltage is increased to minimize the line losses and voltage drop, the charging current also increases.

DC transmission can be achieved more efficiently over longer distances than AC transmission. Medium voltage (MV) or high voltage (HV) DC transmission typically requires power electronic converters which are capable of converting between HV AC and HV DC. In conventional converter topologies, each switch of the converter is designed to handle high voltages which may range from tens of kilovolts to hundreds of kilovolts depending upon the application. Such switches are typically arranged with series connection of several semiconductor devices such as insulated gate bipolar transistors (IGBTs) and thyristors.

In another converter topology (U.S. Pat. No. 7,851,943), switches are used within modules of lower voltage rating and the modules are connected in series to obtain a high voltage. To increase the system reliability and availability, the number of modules connected can be higher than the number dictated by maximum output voltage that will be applied to the system. Any of the modules can be disconnected from the system in case of faults or defected components by short-circuiting its output and disconnecting it from the system. However, this converter topology has a high number of components which increases it cost and reliability.

Therefore, it is desirable to determine a method and a system that will address the foregoing issues.

### BRIEF DESCRIPTION

In accordance with one embodiment of the present technique, a system for transmitting direct current (DC) power is provided. The system includes a system DC link configured for carrying power from a source to a plurality of loads and alternating current (AC) to DC power converter modules coupled in series to the system DC link on a supply side of the system DC link. The at least one AC to DC power converter module is connected to the source via at least one controllable semiconductor switch such that when the controllable semiconductor switch is not conducting, the at least one AC to DC power converter module adds about zero voltage to a system DC link voltage and provides a path for a DC link current.

In accordance with another embodiment of the present technique, a method for transmitting DC power is provided. The method includes providing a system DC link configured for carrying power from a source to a load and coupling alternating current (AC) to DC power converter modules in series to the system DC link on a supply side of the system DC link. The method further includes coupling at least one AC to DC power converter module to the source via at least one controllable semiconductor switch such that when the controllable semiconductor switch is not conducting, the at least one AC to DC power converter module adds about zero voltage to a system DC link voltage and provides a path for a DC link current.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a system for transmitting DC power in accordance with an embodiment of the present technique;

FIG. 2 is a block diagram of a source side converter in accordance with an embodiment of the present technique; and

FIG. 3 is a circuit diagram of a DC to DC converter.

### DETAILED DESCRIPTION

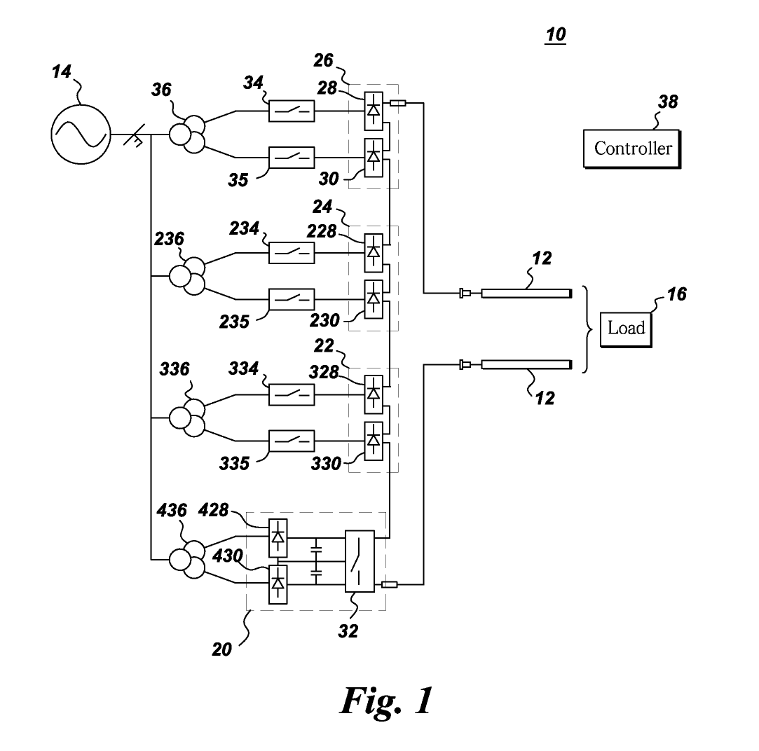

FIG. 1 is a block diagram of one embodiment of a system 10 for transmitting direct current (DC) power to a subsea load. System 10 comprises a system DC link 12 configured for carrying power from a source 14 (meaning at least one source) to a load 16 (meaning at least one load), and alternating current (AC) to DC power converter modules 20, 22, 24, 26 coupled in series to system DC link 12. AC to DC power converter modules 20, 22, 24, 26 may include series connected 3 phase Diode Bridge rectifiers 28, 30, 228, 230, 328, 330 or series connected 3 phase diode bridge rectifiers 428, 430 followed by another DC to DC converter 32 or any combinations thereof. In one embodiment, DC to DC converter 32 may include a 2 or 3 levels H bridge module. The 3 levels H bridge module may be a diode clamped converter module.

In one embodiment, 3 phase diode bridge rectifiers 28, 30, 228, 230, 328, 330 are fed by supply side transformers 36, 236, 336 of the system DC link via controllable semiconductor switch modules 34, 35, 234, 235, 334, 335. Diode bridge rectifiers 428, 430 are fed by supply side transformers 436. In one embodiment, each of transformers 36, 236, 336, 436 has two secondary windings each coupled to a separate 3 phase diode bridge rectifier 28, 228, 328 or 30, 230, 330, 428, 430. The controllable semiconductor switch modules 34, 35, 234, 235, 334, 335 each may include two sets bidirectional semiconductor switches (not shown) provided at the two AC phase inputs of 3 phase diode bridge rectifiers 28, 30, 228, 230, 328, 330 that can open at least 2 of the 3 phase inputs. In one embodiment, the bidirectional semiconductor switch may include back to back connected unidirectional semiconductor switches or a combination of an unidirectional semiconductor switch and a diode bridge. Furthermore, the semiconductor switches may be thyristors, insulated gate commutated thyristors (IGCTs) or insulated gate bipolar transistors (IGBTs).

The embodiment of FIG. 1 is particularly useful for transmitting bulk electrical power from a source to a distant load using DC transmission wherein the DC voltage level is at least medium (for example, at least ten kilovolts). Typically the distances are greater than twenty kilometers but what is considered “distant” will vary depending upon power requirements of the load. Additionally, some applications may exist wherein the benefits of stringing load-side power conversion modules in DC are not dependent upon long distances. In sub-sea embodiments, for example, the source may be at a long distance from the load (for example, on-shore to off-shore transmission for sub-sea loads) or may be at a short distance (for example, transmission to sub-sea loads from a topside platform wherein distance is typically four kilometers to five kilometers). When used to supply power to loads situated in sub-sea, the embodiment of FIG. 1 is expected to reduce cost, complexity, and required space for power conversion equipment.

In operation, each of AC to DC converters 20, 22, 24, 26 provides a DC level voltage, all of which are added together due to the series connection between the AC to DC converters to form a DC link voltage Vdc. In one embodiment, the DC voltage level of AC to DC converter 20 (or DC to DC converter 32) may be a positive voltage level, a negative voltage level or a zero voltage level. Furthermore, at least one DC to DC converter 32 is controlled to regulate a current Id flowing through system DC link 12 by providing a positive, a negative or zero voltage at its output terminals.

In one embodiment, when the two sets of back to back connected semiconductor switches provided at the two AC inputs of the diode bridge rectifier are triggered not to conduct (or not triggered to conduct) then the respective diode bridge rectifier provides a zero voltage at its output terminals and subsequently adds no voltage to the overall DC link voltage. In other words, semiconductor switch modules 34, 35, 234, 235, 334, 335 when not conducting can bypass the respective AC to DC converter. A controller 38 which controls system 10 is configured to trigger at least one set of semiconductor switch modules not to conduct in the event of a fault condition. Furthermore, when one AC to DC converter is bypassed, other AC to DC converter modules are configured to independently remain in operation. This feature enables the elimination or reduction of DC circuit breakers at the output side. It should also be noted that when one set of back to back connected semiconductor switches is conducting and other set is not conducting, the respective diode bridge rectifier would provide a reduced DC level voltage as only 2 out of the 3 phases would be connected to the diode bridge rectifier. In another embodiment, additional mechanical switches or circuit breakers (not shown) could be added in series with the bidirectional switches for system maintenance. In yet another embodiment, AC to DC converters 22, 24, 26 define most of the DC link voltage (e.g., 98%) whereas AC to DC converter 20 is used to slightly tweak or fine tune the DC link voltage (e.g., +/−5%). In other words, AC to DC converter 22, 24 and 26 provide bulk power when required whereas AC to DC converter 20 operates as a vernier.

One of the advantages of the present technique is that it needs reduced filter elements at input side. In general, since AC to DC converters 22, 24 and 26 or the relevant diode bridges do not have capacitors at their output terminals; there are not any spikes in the input currents. This results in reduced filtering components at input side. Another advantage of the present technique is that it requires less space as it reduces overall system components. Because the overall proposed system described herein requires less space as compared with conventional embodiments, it is possible to use additional converters if increased redundancy is desired.

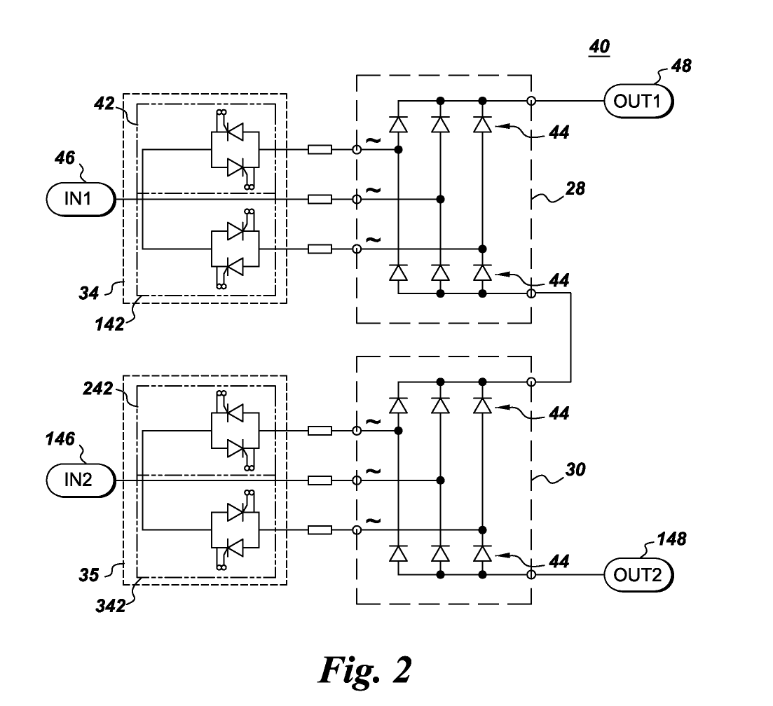

FIG. 2 shows a detailed block diagram 40 of a source side converter which is connected in series with a DC link. As can be seen the two—3 phase diode bridge rectifiers 28, 30 are connected in series and output terminals 48, 148 provide a DC level voltage which is then added with other series connected converters and define a DC link voltage. It should be noted that even though input side terminals 46, 146 are shown as single input, each of input side terminals 46, 146 include 3 phase inputs which may come from a transformer secondary winding. In one embodiment, at least 2 phase inputs of input side terminals 46, 146 are connected to the 3 phase diode bridge via controllable semiconductor switch modules 34, 35. Thus, when controllable semiconductor switch module 34, 35 is not conducting diodes 44 in that respective phase of the 3 phase diode bridge are open circuited from the input side. If both controllable semiconductor switch modules 34, 35 related to the 3 phase diode bridge rectifier are not conducting then 2 phases of that diode bridge rectifier are disconnected from the input and thus, the diode bridge rectifier provides about zero voltage while still allowing a path for a DC link current flow. If both diode bridge rectifiers 28 and 30 provide zero voltage then at output terminals 48, 148 there will be a zero voltage as well.

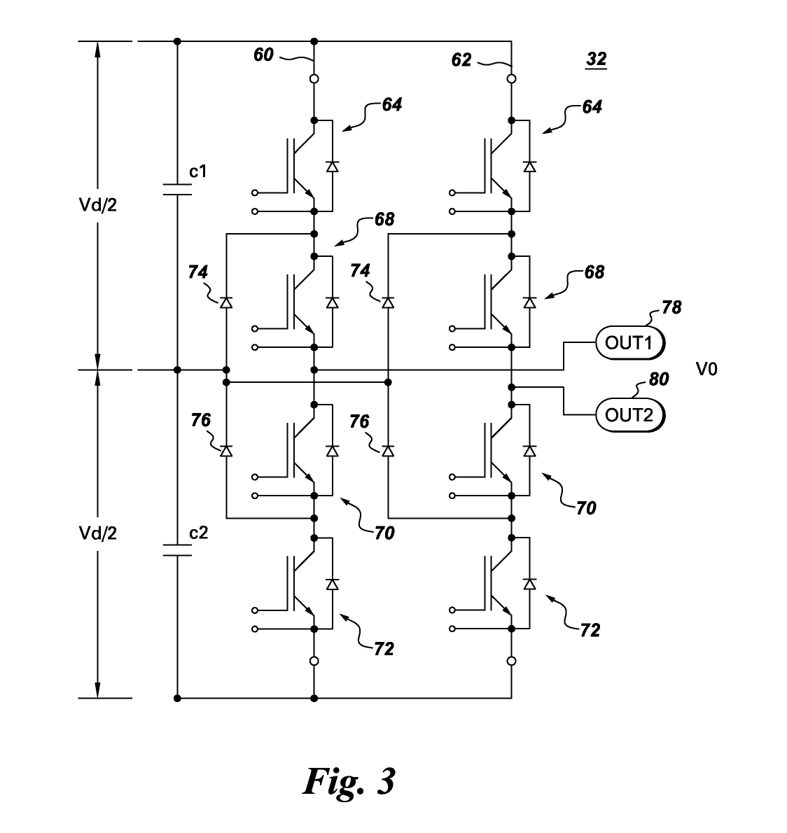

FIG. 3 illustrates a schematic of a DC to DC converter 32 (FIG. 1). It should be noted that the converter shown here is only for illustrative purpose and in other embodiments any other DC to DC converter such as a buck converter may also be used. DC to DC converter 32 includes two legs 60, 62 each including four switching devices 64, 68, 70 and 72 and two diodes 74 and 76. Input voltages Vd/2 across input capacitors C1 and C2 are provided by diode bridge rectifiers 28, 30 (FIG. 1). Voltage V0 is the output voltage measured at output terminals 78, 80. Device 64 is complementary to device 70 so that, when device 64 is conducting, device 70 is not conducting and vice versa. Similarly, devices 68 and 72 are complementary.

In operation, each leg of DC to DC converter 32 has three switching stages. In the first switching stage, devices 64 and 68 are turned on and devices 70 and 72 are turned off, in the second switching stage, devices 68 and 70 are turned on whereas in the third switch stage, devices 70 and 72 are turned on. Assuming voltage across capacitors c1 and c2 each to be Vd/2, output voltage V0 has 5 levels, Vd, Vd/2, 0, −Vd/2 and −Vd depending on switching states of legs 60 and 62. As can be seen from FIG. 1, voltage V0 is eventually added to DC link voltage Vdc and since it has 5 different levels it can vary the overall DC link voltage and can control the current in the system DC link 12.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for transmitting direct current (DC) power comprising:
a system DC link for carrying power from a source to a plurality of loads; and
alternating current (AC) to DC power converter modules coupled in series to the system DC link on a supply side of the system DC link;
wherein at least one AC to DC power converter module is connected to the source via at least one controllable semiconductor switch such that when the controllable semiconductor switch is not conducting, the at least one AC to DC power converter module adds about zero voltage to a system DC link voltage and provides a path for a DC link current.

2. The system of claim 1, wherein the at least one controllable semiconductor switch includes at least two sets of bidirectional semiconductor switches.

3. The system of claim 2, wherein the bidirectional semiconductor switch comprises back to back connected controllable unidirectional semiconductor switches or a combination of an unidirectional switch and a diode bridge.

4. The system of claim 3, wherein when at least one set of back to back connected controllable unidirectional semiconductor switches is triggered to conduct, the respective AC to DC power converter module adds a DC level voltage to the system DC link voltage.

5. The system of claim 3, wherein controllable unidirectional semiconductor switches include thyristors, insulated gate commutated thyristors (IGCTs) or insulated gate bipolar transistors (IGBTs).

6. The system of claim 1, wherein AC to DC power converter modules comprise at least one diode bridge rectifier.

7. The system of claim 1, wherein AC to DC power converter modules comprises two diode bridge rectifiers connected in series.

8. The system of claim 1, wherein AC to DC power converter modules comprise at least one diode bridge rectifier coupled to a DC to DC converter.

9. The system of claim 8, wherein at least one DC to DC converter is configured to control a DC current in the system DC link.

10. The system of claim 8, wherein the DC to DC converter comprises a two or a three-level H-bridge converter.

11. The system of claim 8, wherein the DC to DC converter comprises a buck converter.

12. The system of claim 1, wherein each AC to DC power converter module is configured to independently remain in operation when another of the AC to DC power converter modules is adding zero voltage to the system DC link voltage.

13. The system of claim 1 further comprising a controller configured for triggering at least one set of switches in the event of a fault condition.

14. The system of claim 1, wherein at least some of the plurality of loads are situated sub-sea.

15. A method for transmitting direct current (DC) power comprising:
providing a system DC link configured for carrying power from a source to a load;
coupling alternating current (AC) to DC power converter modules in series to the system DC link on a supply side of the system DC link;
coupling at least one AC to DC power converter module to the source via at least one controllable semiconductor switch such that when the controllable semiconductor switch is not conducting, the at least one AC to DC power converter module adds about zero voltage to a system DC link voltage and provides a path for a DC link current.

16. The method of claim 15, wherein coupling at least one AC to DC power converter module to the source via at least one controllable semiconductor switch includes utilizing at least two sets of bidirectional semiconductor switches.

17. The method of claim 16, wherein the bidirectional semiconductor switch comprises back to back connected controllable unidirectional semiconductor switches or a combination of an unidirectional switch and a diode bridge.

18. The method of claim 15, wherein when at least one set of back to back connected controllable unidirectional semiconductor switches is triggered to conduct, the respective AC to DC power converter module adds a DC level voltage to the system DC link voltage.

19. The method of claim 18, wherein AC to DC power converter modules comprise at least one diode bridge rectifier coupled to a DC to DC converter.

20. The method of claim 19, wherein the DC to DC converter comprises a two or a three-level H-bridge converter or a buck converter.
